(19) United States
(12) Patent Application Publication
(10) Pub. No.: US 2009/0155693 A1
(43) Pub. Date: Jun. 18, 2009

(54) DISPERSED SOLUTION OF CARBON-CONTAINING MATERIALS FOR THE PRODUCTION OF CURRENT COLLECTORS

(75) Inventors: Cristelle Portet, Toulouse (FR); Pierre-Louis Taberna, Roques sur Garonne (FR); Patrice Simon, Toulouse (FR); Christel Laberty-Robert, Alexandria, VA (US)

Correspondence Address: YOUNG & THOMPSON, 209 Madison Street, Suite 500, ALEXANDRIA, VA, 22314, US

(73) Assignees: UNIVERSITE PAUL SABATIER, Toulouse (FR); CENTRE NATIONAL DE LA RECHERCHE SCIENTIFIQUE, Paris (FR)

(21) Appl. No.: 12/088,243

(22) PCT Filed: Sep. 29, 2006
(86) PCT No.: PCT/FR2006/002205

§ 371 Date: Jul. 17, 2008

(30) Foreign Application Priority Data
Sep. 29, 2005 (FR) 0509933

(51) Int. Cl. H01M 4/58

(52) U.S. Cl. 429/231.8

(57) ABSTRACT

A method of preparing a dispersed solution of carbon-containing particles of nanometric size includes: preparing a polymeric matrix of a determined viscosity, then introducing into the matrix a fraction of carbon-containing particles and a fraction of wetting agent, the solvent of the matrix, and maintaining under agitation until a sol of stable viscosity is obtained, these operations being repeated until the carbon-containing particles and the solvent are exhausted. The dispersal solution includes: in a ratio to the total volume of solution: i) 1% to 4%, preferably 2% to 4% (m/v), of carbon-containing particles in suspension, ii) 20% to 40% (v/v) of a polymeric matrix, and iii) a wetting agent, the solvent of the polymeric matrix, said dispersed solution comprising neither binder nor dispersing agent.

The present invention relates to the field of active layers of current collectors which are used in systems for storing energy, such as secondary batteries, capacitors and superconductors.

The subject thereof is a composition with is intended for the production of improved current collectors and a method for preparing such a composition. Another subject of the invention is a method for producing an improved collector which comprises an intermediate layer having notable and original conduction properties.

The systems for storing electrical energy, whether via an electrochemical route or an electrostatic route, are mainly formed by a current collector, which is the metallic conductor which drains the electrons from an electrolyte, and an active film which comprises the active material which makes the storage of the energy possible. Active films are for example redox systems in batteries, activated charcoal in supercapacitors or the dielectric film in capacitors.

For effective operation, it is necessary to limit to the maximum the resistance to the passage of the current in the system from the electrolyte to the active film. This resistance depends upon a number of factors but the two main contributory factors are the resistance of the electrolyte and the resistance of the interface between the current collector and the active film, this resistance depending to a large extent upon the nature of the interface layer and the quality of the contact.

Various methods have been proposed in order to improve the conductivity between collector and active film. For example, for aluminium collectors, it has been attempted to eliminate the hydrated alumina layer which naturally protects the surface, corresponding to the phenomenon of passivation, and contributes to augmenting the resistance to the aluminium interface-active material.

The U.S. Pat. No. 6,191,935 for example describes a technique for producing an aluminium current collector in which hard granular carbon powders are made to penetrate by compression in order to break the insulating alumina layer and thus to reduce the resistance. However, the stability of the contact between the active material and the collector is not ensured after a certain time has elapsed.

In the U.S. Pat. No. 5,949,637, a technique is described in which aluminium collector supports in the form of sheets are pierced in order to reduce the contact resistance between the active material and the aluminium sheet.

The U.S. Pat. No. 6,094,788 describes a current collector which is surrounded by a carbon fabric. This assembly requires the use of a depassivated aluminium sheet in order to reduce the resistance between active material and collector. However, nothing is provided as far as the pre-existing alumina layer is concerned which can be relatively thick and have an increased contact resistance.

In the application JP 111 624 470, a current collector made of an aluminium sheet is described, the surface of which has been vapour-deposited with aluminium grains in order to increase the roughness and to confer improved adherence of the active material on the aluminium sheet. This method, whilst it makes it possible to reduce the contact resistance between the collector and the active material, has the disadvantage of not protecting the collector from subsequent passivation.

Other techniques are based on coating the collector with a protective layer. It has likewise been proposed in the application EP 1 032 064, relating to a current collector of a positive electrode of the paste-coated type, to produce a polymeric covering comprising an oxalate and a compound of silicon, of phosphate or of chrome. This method makes it possible to protect the collector from corrosion caused by the paste coating during production of the electrodes but has practically no effect on the operating characteristics.

The U.S. Pat. No. 4,562,511 for its part describes a polarisable carbon electrode. It is proposed there to cover the aluminium collector with paint which is laden with conductive particles. In FR 2 824 418, a layer of paint including conductive particles, such as graphite or carbon, is applied between the collector and the active material, then is subjected to a thermal treatment which by eliminating the solvent improves the electrical characteristics of the interface. The paint, based on epoxy resin or polyurethane, is applied by spraying. In spite of the improvement conferred by these paints, the latter have the disadvantage of containing binders which increase the interface resistance.

More recently, a new method has been tested in the laboratory which comprises depositing a layer of carbon-containing material on the porous surface of an aluminium current collector. The porosity is obtained by chemical etching, then a conductive layer which is supposed to ensure the continuity of contact between the porous surface of the collector and the active film is deposited.

The physical properties of the material or materials forming this layer are very important not only for the operation of the current collector but also for its production. In fact, the conductive material must be able to be applied in a fine layer which is adhesive and covering, i.e. the layer must be uniform, homogeneous and, as an essential condition, in contact with its support at all points.

However, it has been confirmed that the coatings laden with conductive material which have been used to date do not penetrate into the pores and the exchange surface is in fact reduced. In fact the coating drops are incapable of overcoming the surface forces in order to penetrate into the porosity. It is noted likewise that the size of the conductive particles must be of the order of a few tens of nanometres at most in order to be able to penetrate into the deep pores which have a diameter of a few microns, whilst the coating drops measure a few tens of microns. In order to resolve this problem and to produce a continuous interface between the active material and the porous current collector, it has been envisaged to deposit on the collector a suspension of finely divided conductive material in a polymeric matrix forming a sol.

It is known via the application FR 2 856 397 to use sols for the preparation of metallic oxide layers on substrates, which are porous or not. The method used comprises dispersing a metallic oxide in a solvent supplemented by a dispersing agent, then adding to this mixture a polymeric solution. The suspension which is thus obtained is then deposited on the substrate by immersion-withdrawal (known under the name “dip-coating”), dried and calcinated in order to eliminate the organic matrix and to leave only an oxide layer. However this technique cannot be transferred to the implementation of fine carbon particle dispersions. In fact, the carbon powders, such as acetylene black or activated charcoal, do not have the same behaviour relative to solvents. They do not disperse correctly and form aggregates which, on the one hand, modify the viscosity of the sol and, on the other hand, make irregularities appear in the layer after calcination. Furthermore, the additives such as dispersing agents, impair good conduction of the interface. The sol-gel route, which is known for making the deposition of oxides possible, had therefore not been explored for putting into suspension and depositing carbon-containing material.

Unexpectedly, it was found that carbon-containing powders of a nanometric size were able to be dispersed homogeneously in a polymeric matrix via the sol-gel route, with the proviso of observing a certain number of conditions, some of which are counter to known expertise in this field. In particular, the order and the duration of the preparation steps assume great importance for obtaining a homogeneous dispersion of the desired viscosity.

Once the dispersion of the carbon-containing material in the polymeric matrix has been achieved, the current collector can be covered by this sol via “dip-coating” (immersion-withdrawal). Thanks to the surface tension properties of the sol, the composition penetrates into the porosity and covers the entire surface of the support. The latter is then treated thermally in order to eliminate the polymeric matrix. A support is therefore obtained, for example a current collector, the surface of which is covered with a continuous uniform layer of conductive carbon-containing particles.

The present invention therefore also has as a first subject a method for preparation of a dispersion of carbon-containing particles in a polymeric matrix via the sol-gel route. A second subject of the present invention is a solution which is able to be obtained by the method in question, comprising a dispersion of carbon-containing particles in a sol. Another subject of the present invention is a method for deposition of a homogeneous conductive layer on a metallic support which is intended for the production of a current collector with low resistance.

More precisely, the subject of the invention is a method for preparation of a dispersed solution of carbon-containing particles of nanometric size, which comprises neither binder nor dispersing agent, essentially comprising:
a)—preparing a polymeric matrix of a determined viscosity,
b)—introducing into said matrix a fraction of carbon-containing particles and a fraction of a wetting agent, the solvent of said matrix,
c)—maintaining under agitation until a sol of stable viscosity is obtained,
d)—repeating steps b) and c) until the carbon-containing particles and the solvent are exhausted.

Strictly speaking, the polymeric matrix is prepared in advance for the suspension of the particles. The temperature thereof must be left to stabilise in order to ensure that it has the desired viscosity before beginning the preparation of the sol. The person skilled in the art has various techniques at his disposal for preparing such a matrix with a fixed viscosity which does not vary in the course of time. Details will be given further on about this subject. The value of the desired viscosity for the matrix is in fact a function of the desired viscosity of the final dispersed solution.

The introduction of the particles into the matrix must be implemented by reduced fractions, in parallel with the addition of solvent. Various matrix-solvent pairs can be used. It is nevertheless necessary that the chosen solvent plays at the same time the role of wetting agent of the carbon-containing particles in order that the latter can be introduced and dispersed in the polymeric matrix. During this entire preparation process for the dispersed solution, the sol must be maintained under vigorous agitation in order to break the agglomerates of carbon-containing material which are able to be formed and to ensure their dispersion.

The principle of this preparation comprises progressively adding small quantities of carbon-containing material and solvent. In order to obtain a good quality dispersed solution, i.e. homogeneous and stable over time, in particular with respect to the viscosity, it is advisable to choose the proportions and operating conditions defined hereafter.

According to one feature of the method according to the invention, at each implementation of step b), 0.5 g to 5 g of carbon-containing particles, preferably 1 g to 3 g, are provided for 100 ml of polymeric matrix.

According to another feature of the method according to the invention, during the first implementation of step b), said solvent is provided in the ratio of at least 100 ml for 100 ml of polymeric matrix.

Preferably, when step b) is repeated, said solvent is provided in the ratio of 20 ml to 50 ml for 100 ml of polymeric matrix.

Advantageously, when step b) is repeated, the ratio of carbon-containing particles/solvent is between 1 and 10% (m/v), preferably between 3% and 6% (m/v). This feature is important if it is desired to obtain a dispersed solution which has a given viscosity level which is adequate for the subsequent deposition of homogeneous films. In fact the viscosity increases with the quantity of carbon-containing material even though a solvent such as acetylacetone for example produces greater fluidity. Furthermore, too great an addition of carbon-containing particles associated with too small a quantity of solvent causes precipitation of the sol and its hardening. In practice it was able to be shown that after three additions according to step b), the carbon-containing particles already show good dispersion and the sol is more diluted, which reduces the risks of hardening. The ratio of carbon-containing particles/solvent can then be greater, for example between 4% and 10% (m/v).

According to an interesting feature of the invention, steps b) and c) are implemented at least 4 times, preferably at least 6 times. In certain cases, if it is desired to obtain a dispersed solution which has an increased concentration of carbon-containing particles, it can be necessary to repeat steps b) and c) up to 7 times or even more.

Be that as it may, it is crucial for obtaining the desired result, in step c), to maintain the sol under agitation until stabilisation of the viscosity. In fact it has been confirmed that the sol was thixotropic: its viscosity develops in the course of time, a reduction being observed here. Maintaining under agitation for two hours can sometimes be sufficient but it is normal to maintain the agitation for at least 4 hours, this duration being able to be extended up to 8 hours and even 12 hours for certain preparations. When a dispersed solution of new composition, the exact behaviour of which is not yet known, is to be prepared, care should be taken to measure the viscosity of the sol at regular time intervals in order to control its development. A measure of viscosity for a given shear stress can be made easily with the help of a common viscosimeter such as for example a Couette viscosimeter. It should be considered that two values of viscosity measured at a one hour interval which have a deviation of less than 5% show a stabilisation which makes it possible to continue the preparation process.

According to an advantageous feature of the method according to the invention, the sol is now subjected to ultrasound before and after each implementation of step b).

In the end, according to a preferred embodiment of the invention, in total from 1 g to 4 g of carbon-containing particles are introduced for 100 ml of final dispersed solution. In a more preferred manner, 2 g to 3 g of carbon-containing particles are introduced for 100 ml of final dispersed solution. According to another preferred embodiment of the method according to the invention, in total 60 ml to 80 ml of solvent are introduced for 100 ml of final dispersed solution. These concentrations will make it possible, during deposition of the dispersed solution on a substrate, to obtain a covering, uniform carbon-containing layer.

In the method according to the invention, said carbon-containing particles of nanometric size are advantageously chosen from materials doped with a high capacity conductor, such as acetylene black, activated charcoal, carbon nanotubes or even graphite.

The wetting agent, which must likewise be a solvent of said polymeric matrix, is advantageously chosen from acetylacetone or ethanol.

According to an advantageous embodiment of the invention, the polymeric matrix can be obtained by one of the following methods:
either by condensation of hexamethylenetetramine (HMTA) and of acetylacetone in an acid medium, and a matrix, termed “simple” is obtained,
or by condensation of HMTA and of acetylacetone in an acid medium, then addition of ethylene glycol, and a matrix termed “mixed” is obtained.

The preparation of a simple polymetric matrix from HMTA and acetylacetone is well known to the person skilled in the art who will be able to use the required proportions to obtain the desired viscosity matrix. A particular example will illustrate this preparation.

The second method, for its part, is quite innovative. It stems from the observation that mechanical degradation affects the current collectors produced from a simple matrix of a relatively low viscosity during the thermal treatment. This new composition of the sol has the advantage of maintaining the particles in suspension and making them adhere to the substrate on which they are intended to be deposited, whilst conferring a slower drying speed for a satisfactory viscosity. Although the action mechanism of the ethylene glycol has not been studied per se, it is assumed that it acts on the drying speed of the sol, which is clearly slower, and reduces the mechanical stresses due to retraction of the layer which avoids the deformation of low thickness substrates.

The mixed matrix according to the invention can be formed with variable proportions of polymer and ethylene glycol. Compositions, the volumetric ratio of polymer/ethylene glycol of which is between 1:3 and 2:1 can be used advantageously. Preferably, the polymeric matrix comprises quantities of polymer and ethylene glycol in a ratio of 1:2 by volume.

When it is desired to use the dispersed solution for deposition of a conductive layer on a substrate, it is preferable that the final viscosity is within a particular range which is facilitated if the polymeric matrix also initially has a certain viscosity. This is why, according to a preferred embodiment of the invention, the polymeric matrix obtained in step a) has a viscosity between 10 cPl and 25 cPl.

According to a likewise preferred embodiment of the invention, at the end of each step c), the sol has a viscosity between 10 cPl and 40 cPl. This viscosity corresponds to the constraints defined by the intended use of the suspension according to the invention which must be able to be used via the immersion-withdrawal method for forming a layer of a given thickness, of the order of 30 □m to 50 □m, providing a quantity of carbon-containing material of a relatively low density, i.e. of the order of 0.5 mg/cm² to 1.5 mg/cm².

A dispersed solution which is able to be obtained by the previously described method is likewise a subject of the present invention. More precisely, a dispersed solution of carbon-containing particles of nanometric size is the subject of the invention, comprising in a ratio to the total volume of solution:
i) 1% to 4%, preferably 2% to 4% (m/v), of carbon-containing particles in suspension,
ii) 20% to 40% (v/v) of a polymeric matrix, and
iii) a wetting agent, the solvent of the polymeric matrix, said dispersed solution comprising neither binder nor dispersing agent.

According to a preferred embodiment, the carbon-containing particles are chosen from conductive materials, such as acetylene black, activated charcoal, carbon nanotubes or graphite.

According to another preferred embodiment, said polymeric matrix is a condensation product of hexamethylenetetramine (HMTA) and of acetylacetone, pure (simple matrix) or diluted in ethylene glycol (mixed matrix). The mixed matrix can contain variable proportions of polymer and ethylene glycol. Advantageously, the volumetric ratio of polymer/ethylene glycol is between 1:3 and 2:1. Preferably the quantities of polymer and ethylene glycol are in a ratio of 1:2 by volume.

According to yet another preferred embodiment, said wetting agent, the solvent of the polymeric matrix, is chosen from acetylacetone or ethanol.

Finally, a dispersed solution of carbon-containing particles, such as described above, is the subject of the present invention, prepared with the help of the method according to the invention.

Preferably, the dispersed solution of carbon-containing particles according to the invention has a viscosity between 10 cPl and 40 cPl, which makes it possible to use it for deposition by dip-coating of a uniform carbon-containing layer on a substrate.

The dispersed solutions of carbon-containing particles can have various uses. For example, a dispersion according to the invention can be used advantageously for the preparation of conductive layers on a substrate, in particular intended for the production of a current collector, such as those found in systems for storing electrical energy. This use is particularly of interest in so far as it exploits at the same time the dispersion properties and the adhesion properties of the sol.

One subject of the present invention is therefore a method for preparation of a conductive carbon-containing layer on a substrate, essentially comprising:
preparing a dispersed solution of carbon-containing particles of nanometric size according to the invention,
depositing a layer of said dispersed solution on said substrate,
drying said layer in the open air,
eliminating said at least one polymer by thermal treatment, and
eliminating the carbon-containing particles which are not adhering to the substrate by brushing.

The material to be deposited on the collector is therefore firstly put into suspension in a polymeric matrix according to the invention. It is chosen preferably from carbon-containing materials which have an increased electronic conductivity, such as graphite, carbon black, activated charcoal, carbon nanotubes.

The deposition of the dispersed solution can be implemented in various ways known to the person skilled in the art: by immersion-withdrawal (also termed “dip-coating”), spin-coating or slip coating.

According to an advantageous feature of the method for preparation of a conductive carbon-containing layer according to the invention, said dispersed solution of carbon-containing particles has a viscosity between 10 cPl and 40 cPl and is deposited on said substrate by immersion-withdrawal at a speed of at least 25 cm/mn. This technique makes it possible to deposit a layer of a controlled constant thickness containing the carbon-containing material, by acting on the shrinkage speed for a given viscosity.

The drying step is important for the quality and performance of the final product. It can be implemented solely in the open air and possibly completed by passage through an oven. When a carbon-containing dispersion prepared from a simple matrix is used, the drying time can be of the order of 15 minutes to one hour but it can also range from 10 to 12 hours when it concerns a carbon-containing dispersion prepared from a mixed matrix. Heating to 80° C. for 30 nm can be effected for finishing.

If it is wished to produce depositions on substrates of a small thickness, i.e. from 40 □m to 70 □m, preferably a mixed matrix of a viscosity 10 cPl to 15 cPl is used with ethanol as solvent for preparation of the sol. A carbon-containing suspension can thus be obtained which has a viscosity of the order of 10 cPl to 20 cPl, and the drying time of which before calcination will be several hours long. Such a method is particularly adapted for avoiding mechanical degradation of thin substrates in the course of production.

Once the deposition has been achieved, the layer is calcinated at a temperature of approx. 450° C. for 4 hours. This thermal treatment is sufficient to eliminate the organic matrix and to allow the conductive carbon-containing film to appear, which covers and adheres to the rough surface of the collector. It is noted that when the sol-gel route is used for the synthesis by metallic oxides of a controlled stoichiometry, it is necessary to apply a treatment at high temperatures of the order of 700° C. to 1000° C. or even more which, as is obvious, is totally unsuitable for deposition of a carbon-containing layer on an aluminium support, the fusion temperature of which is 650° C. In addition, this is one reason for which the sol-gel route had never been used until now for the purposes of the invention.

Total calcination of the matrix is necessary for good operation of the collector. Brushing allows in addition elimination of the carbon-containing particles which have not adhered to the substrate at the end of the treatment. This step is likewise indispensable for obtaining the sought capacities.

The technique according to the invention does not require any binder. The obtained film is formed solely from the conductive carbon-containing material, which makes it possible to dispense with the resistance connected to the contribution of the binder. The technique according to the invention no longer makes use of an adhesive polymer as is the case in paint based coverings. Here, the polymeric matrix confers the solution with the desired adhesion properties at the time of deposition, and is then eliminated. No supplementary polymer is necessary for fixing the conductive particles. There again, the resistance connected to an adhesive agent is dispensed with.

According to an advantageous embodiment of the method for preparation of a conductive carbon-containing layer according to the invention, the substrate in question is a porous support made of conductive metal which has been subjected in advance to a chemical surface etching. This concerns for example chemical pickling which makes it possible to produce a rough surface which assists the bonding of the layer and increases the exchange surface.

The application of the method for preparation of a conductive carbon-containing layer according to the invention, for the production of a current collector in a system for storing electrical energy is likewise claimed.

Finally, another subject of the present invention is a system for storing electrical energy comprising a metallic current collector and an active film characterised in that said current collector is covered with a conductive layer obtained with the help of a solution of carbon-containing particles according to the description detailed previously.

These systems for storing electrical energy can be in particular:
secondary batteries (rechargeable), Li-ion or Li-polymer accumulators, mainly positive electrodes,
superconductors based on activated charcoal or metallic oxides (positive and negative electrodes),
electrochemical capacitors, essentially positive electrodes.

The current collectors obtained with the help of the techniques described here have improved properties relative to conventional collectors. They have a reduced contact resistance between the active film and the current collector: the resistance of test cells assembled in the laboratory with aluminium current collectors reduces 20% to 50% relative to the resistance of cells using standard aluminium current collectors. The results obtained with stainless steel strips, of the Fe—Cr and Fe—Cr—Ni type, are of the same order. The overall resistance of the supercapacitors produced thanks to the method according to the invention are seen to be reduced, which makes it possible to obtain a significant increase in the specific mass power.

Other advantages and interesting properties will emerge better in the light of the following examples given by way of example.

All the viscosity measurements are implemented at 0° C. at a constant shear speed (speed of rotation 325 cm/mn) with the help of a Couette Viscosimeter (Lamy-Tve-05, position 3).

### EXAMPLE 1

### Preparation of a Simple Polymeric Matrix

26.25 g of HMTA and 20 ml of acetylacetone are mixed, to which there are added 100 ml of acetic acid. The mixture is left under magnetic agitation until dissolution of the HMTA, then is heated to 100° C. for 1 hour whilst maintaining the agitation. The formed polymeric matrix is cooled to ambient temperature. Once cooled it has a viscosity which is stable over time, measured at 17 cPl.

The proportions of ingredients can easily be varied in order to obtain a matrix with a viscosity between 10 cPl and 25 cPl. Such matrices are well adapted to the preparation of dispersed solutions which are intended for the deposition of carbon-containing material on substrates of a thickness greater than 100 □m.

### EXAMPLE 2

### Preparation of a Mixed Polymeric Matrix

The simple matrix based on HMTA, prepared as described in Example 1, is mixed with ethylene glycol until a homogeneous gel is obtained. In this example we used 2 volumes of ethylene glycol for 1 volume of HMTA matrix. The viscosity of this matrix is 12 cPl.

The proportions of ingredients can easily be varied in order to obtain a mixed matrix which has a viscosity between 10 cPl and 15 cPl. Such matrices are well adapted to the preparation of dispersed solutions which are intended for the deposition of carbon-containing material on thin substrates (of a thickness less than 100 □m).

### EXAMPLE 3

### Preparation of a Dispersion of Acetylene Black in a Simple Matrix

It is necessary to prepare 120 ml of a dispersion containing 3 g of acetylene black. The carbon-containing material chosen is acetylene black, the average particle size of which is of the order of 50 nm (Alfa Aesar, Carbon Black, ref 2311533) which will be dispersed in a simple polymeric matrix based on HMTA. The solvent is acetylacetone.

A quantity of 30 ml of polymeric matrix, prepared as indicated in example 1, is put under agitation in an adapted receptacle. The initiation of the sol is implemented by introducing 0.25 g of acetylene black wetted by 40 ml of acetylacetone. A sol is formed which is left under agitation for 12 hours in order to assist the dispersion of the acetylene black and to avoid the sol hardening.

Then successive additions of 0.5 g of acetylene black and 10 ml of acetylacetone are effected at intervals of 12 hours, which corresponds to the duration necessary for stabilisation of the viscosity (the sol is thixotropic, its viscosity reducing in the course of time). The sol is maintained permanently under magnetic agitation at 500 rpm. It is subjected to ultrasonic agitation (frequency 30,000 Hz, power 200 W) for a few minutes before and after each addition of ingredients. This operation is repeated n times, the number of repetitions being calculated in the following manner: in order to obtain 120 ml of dispersed solution from 30 ml of polymeric matrix it is necessary to add 90 ml of acetylacetone, 40 ml of which is for the initiation phase and 50 ml for repeating step b) 5 times. Furthermore, the 3 g of acetylene black will be introduced in the ratio of 0.25 g for the initiation phase and 2.75 g for repeating step b) 5 times, or 2.5 g, then making a final adjustment, by a single addition of 0.25 g of acetylene black.

The preparation of the dispersion is therefore implemented over several days. Its final viscosity is 10.6 cPl.

This example can be varied by modifying the quantities of ingredients and the number of successive additions, within a certain limit and taking into account the particular effect of each of the ingredients on the characteristics of the sol. In fact, the carbon-containing material reduces the viscosity of the sol whilst the acetylacetone allows it to be increased. It has been confirmed in addition that by adding too large a quantity of carbon-containing material associated with too weak a volume of acetylacetone, the sol precipitates and hardens. It is necessary likewise to adapt the volume of the polymeric matrix, the quantity of carbon-containing material and the volume of solvent as a function of the mass of carbon-containing material which it is wished then to deposit on the substrate.

It is necessary therefore to obtain a good compromise which can, for the example detailed above, be adjusted as follows:
30 ml of polymeric matrix prepared according to example 1;
initiation of the sol by 0.25 g of acetylene black wetted by 40 ml of acetylacetone;
addition in 4 to 8 repetitions of 0.3 g to 0.5 g of acetylene black and 10 ml to 20 ml of acetylacetone;
final adjustment by a single addition of acetylene black
   in order to obtain 110 ml to 130 ml of dispersed solution containing 2.5 g to 3.5 g of acetylene black and 80 ml to 100 ml of solvent, of a viscosity between 30 cPl and 40 cPl.

### EXAMPLE 4

### Preparation of a Conductive Carbon-Containing Layer on a Substrate

The dispersed solution prepared according to example 3 is used to produce a deposit on a substrate comprising an aluminium strip of 99.9% purity (Alcan), laminated and then subjected to an electrochemical treatment which produces a porosity formed by deep channels of a few microns in diameter. The thickness of the strip after treatment varies from 150 □m to 250 □m. The deposit is produced by the well known technique of withdrawal-immersion, at a withdrawal speed between 30 cm/mn and 50 cm/mn. The strip is dried in the open air for about thirty minutes then placed in an oven at 80° C. for 30 minutes.

Then the substrate undergoes a thermal treatment by a progressive increase in temperature at a rate of more than 100° C./h, with a stage of 15 nm at 400° C., up to 450° C. The temperature is then maintained at this level for 4 hours in air. The decomposition of the polymeric matrix begins at approx. 250-300° C. At the end of this treatment, the polymeric matrix is totally eliminated which is indispensable for obtaining good conduction capacities of the carbon-containing layer because, the polymeric matrix being insulating, it would impede the passage of current between the aluminium and the active material of the collector. After cooling, the substrate is brushed in order to remove the surplus of carbon-containing materials which have not adhered to the substrate and which can produce defective bonding zones between the current collector and the active material.

The layer deposited on the substrate is uniform, of a thickness between 10 □m and 30 □m. It is homogeneous, adhesive and covering and, as an essential condition, in contact with its support at all points. It is able to be used as conductive carbon-containing interface in a current collector.

### EXAMPLE 5

### Preparation of a Dispersion of Acetylene Black in a Mixed Matrix

280 ml of dispersed solution containing 10 g of acetylene black is prepared. The carbon-containing material chosen is acetylene black, the average size of the particles of which is of the order of 50 nm (Alfa Aesar, Carbon Black, ref 2311533) which will be dispersed in a mixed polymeric matrix based on HMTA and ethylene glycol. The solvent chosen here is ethanol.

A quantity of 120 ml of polymeric matrix, prepared as indicated in example 2, is put under agitation in an adapted receptacle. The initiation of the sol is produced by introducing 3 g of acetylene black wetted by 40 ml of ethanol. A sol is formed which is left under agitation for 4 hours in order to assist the dispersion of the acetylene black and to avoid the sol hardening.

Then successive additions of 2 g of acetylene black and 40 ml of ethanol are effected at intervals of 4 hours, i.e. when the viscosity is stabilised. The sol is maintained permanently under magnetic agitation at 1000 rpm. It is subjected to ultrasonic agitation (frequency 30,000 Hz, power 200 W) for 15 to 30 nm before and after each addition of ingredients. This operation is repeated n=3 times, distributed in the following manner: the necessary 160 ml ethanol are introduced in the ratio of 40 ml in the initiation phase, then 3 repetitions of 40 ml. The 10 g of acetylene black are introduced in the ratio of 3 g in the initiation phase, then 3 repetitions of 2 g, then a single final adjustment of 1 g.

The final obtained composition has a viscosity of 13.6 cPl. It appears that the ethylene glycol assists the rapid stabilisation of the viscosity, which substantially shortens the total duration of preparation.

This example can be varied by modifying the quantities of ingredients and the number of successive additions, within a certain limit and taking into account the particular effect of each of the ingredients on the characteristics of the sol. The example detailed above can be adjusted as follows:
120 ml of polymeric matrix prepared as indicated in example 2,
initiation of the sol by 3 g of acetylene black and 40 ml of ethanol,
addition in 2 to 4 repetitions of 2 g to 4 g of acetylene black and 40 ml to 60 ml of ethanol,
final adjustment by a single addition of acetylene black,
   in order to obtain 200 ml to 360 ml of dispersed suspension containing 6 g to 15 g of acetylene black (preferably from 8 g to 12 g) for a total volume of ethanol of 80 ml to 240 ml, and a viscosity between 10 cPl and 20 cPl.

### EXAMPLE 6

### Preparation of a Conductive Carbon-Containing Layer on a Thin Substrate

The dispersed solution prepared according to example 5 is used to produce a deposit on a substrate comprising an aluminium strip obtained as in example 4, having a thickness of 50 □m to 80 □m. The deposit is produced by the withdrawal-immersion technique, at a withdrawal speed between 25 cm/mn and 35 cm/mn. The strip is dried in the open air for 10 to 12 hours, then placed in an oven at 80° C. for 3 to 4 hours). The substrate then undergoes a thermal treatment at 450° C. for 4 hours according to the same protocol as the one used in example 4. After cooling, the substrate is brushed.

The fine carbon-containing layer deposited on the substrate is uniform, with a thickness between 10 and 30 □m. It is homogeneous, adhesive and covering, in contact with its support at all points. It is able to be used as conductive carbon-containing interface in a current collector.

1. Method for preparation of a dispersed solution of carbon-containing particles of nanometric size, which comprises neither binder nor dispersing agent, characterised in that it essentially comprises:
a)—preparing a polymeric matrix of a determined viscosity,
b)—introducing into said matrix a fraction of carbon-containing particles and a fraction of a wetting agent, the solvent of said matrix,
c)—maintaining under agitation until a sol of stable viscosity is obtained,
d)—repeating steps b) and c) until the carbon-containing particles and the solvent are exhausted.

2. Method according to claim 1, characterised in that, at each implementation of step b), 0.5 g to 5 g of carbon-containing particles, preferably 1 g to 3 g, are provided for 100 ml of polymeric matrix.

3. Method according to claim 1, characterised in that, at the first implementation of step b), said solvent is provided in the ratio of at least 100 ml for 100 ml of polymeric matrix.

4. Method according to claim 1, characterised in that when step b) is repeated, said solvent is provided in the ratio of 20 ml to 50 ml for 100 ml of polymeric matrix.

5. Method according to claim 1, characterised in that when step b) is repeated, the ratio of carbon-containing particles/solvent is between 1 and 10% (m/v), preferably between 3% and 6% (m/v).

6. Method according to claim 1, characterised in that steps b) and c) are implemented at least 4 times, preferably at least 6 times.

7. Method according to claim 1, characterised in that the sol is subjected to ultrasound before and after each implementation of step b).

8. Method according to claim 1, characterised in that in total 1 g to 4 g of carbon-containing particles, preferably 2 g to 3 g, are introduced for 100 ml of final dispersed solution.

9. Method according to claim 1, characterised in that in total 60 ml to 80 ml of solvent are introduced for 100 ml of final dispersed solution.

10. Method according to claim 1, characterised in that said carbon-containing particles of nanometric size are chosen from acetylene black, activated charcoal, carbon nanotubes, graphite.

11. Method according to claim 1, characterised in that said wetting agent, the solvent of said polymeric matrix, is chosen from acetylacetone, ethanol.

12. Method according to claim 1, characterised in that said polymeric matrix is obtained
either by condensation of hexamethylenetetramine and of acetylacetone in an acid medium,
or by condensation of hexamethylenetetramine and acetylacetone in acid medium, then addition of ethylene glycol.

13. Method according to claim 12, characterised in that said polymeric matrix comprises quantities of polymer and ethylene glycol in a ratio between 1:3 and 2:1, preferably in a ratio of 1:2 by volume.

14. Method according to claim 1, characterised in that the polymeric matrix obtained in step a) has a viscosity between 10 cPl and 25 cPl.

15. Method according to claim 1, characterised in that, at the end of each step c), the sol has a viscosity between 10 cPl and 40 cPl.

16. Dispersed solution of carbon-containing particles of nanometric size, characterised in that it comprises, in a ratio to the total volume of solution:
i) 1% to 4%, preferably 2% to 4% (m/v), of carbon-containing particles in suspension,
ii) 20% to 40% (v/v) of a polymeric matrix, and
iii) a wetting agent, the solvent of the polymeric matrix, said dispersed solution comprising neither binder nor dispersing agent.

17. Solution of carbon-containing particles according to claim 16, characterised in that the carbon-containing particles are chosen from acetylene black, activated charcoal, carbon nanotubes, graphite.

18. Solution of carbon-containing particles according to claim 16, characterised in that said polymeric matrix is a condensation product of hexamethylenetetramine and of acetylacetone, pure or diluted in ethylene glycol.

19. Solution of carbon-containing particles according to claim 18, characterised in that said polymeric matrix comprises quantities of polymer and ethylene glycol in a ratio between 1:3 and 2:1, preferably in a ratio of 1:2 by volume.

20. Solution of carbon-containing particles according to claim 16, characterised in that said wetting agent, the solvent of the polymeric matrix, is chosen from acetylacetone, ethanol.

21. Solution of carbon-containing particles according to claim 16, prepared with the help of the method.

22. Solution of carbon-containing particles according to claim 16, characterised in that it has a viscosity between 10 cPl and 40 cPl.

23. Method for preparation of a conductive carbon-containing layer on a substrate, characterised in that it essentially comprises:
preparing a dispersed solution of carbon-containing particles of nanometric size according to claim 16,
depositing a layer of said dispersed solution on said substrate,
drying said layer in the open air,
eliminating said at least one polymer by thermal treatment, and
eliminating the carbon-containing particles which are not adhering to the substrate by brushing.

24. Method for preparation of a conductive carbon-containing layer on a substrate according to claim 23, characterised in that said layer of dispersed solution has a viscosity between 10 cPl and 40 cPl and is deposited on said substrate by immersion-withdrawal at a speed of at least 25 cm/mn.

25. Method for preparation of a conductive carbon-containing layer on a substrate according to claim 23, characterised in that said substrate is a porous support made of conductive metal which has been subjected in advance to a chemical surface etching.

26. Application of the method according to claim 23 for the production of a current collector in a system for storing electrical energy.

27. System for storing electrical energy comprising a metallic current collector and an active film, characterised in that said current collector is covered with a conductive layer obtained with the help of a solution of carbon-containing particles according to claim 16.
